(19) United States
(12) Patent Application Publication
(10) Pub. No.: US 2005/0114249 A1
(43) Pub. Date: May 26, 2005

(54) Method by which an individual can manage his own selected assets, receive the benefits from the selected assets and protect the selected assets from claimants

(76) Inventor: Robert J. Mauceri, Branford, CT (US)

Correspondence Address: WILLIAM C. CRUTCHER;MCCORMICK, PAULDING & HUBER, LLP, 185 ASYLUM STREET, CITY PLACE II, 18TH FLOOR, HARTFORD, CT, 06103-4102, US

(21) Appl. No.: 10/984,059

(22) Filed: Nov. 9, 2004

Related U.S. Application Data
(60) Provisional application No. 60/525,096, filed on Nov. 25, 2003.

(51) Int. Cl. G06F 17/60

(52) U.S. Cl. 705/36; 705/35

(57) ABSTRACT

A method whereby an individual can manage his own selected assets, receive the benefits from the selected assets and protect the selected assets from claimants by combining the features of a limited liability company (LLC) with the features of a domestic asset protection trust (DAPT) in those states having statutes permitting both an LLC and a DAPT.

### CROSS-REFERENCE TO RELATED APPLICATIONS

This application claims the benefits of prior filed, co-pending provisional U.S. patent application Ser. No. 60/525,096 filed on Nov. 25, 2003.

### BACKGROUND OF THE INVENTION

Our society has become increasingly litigious. The cost to a claimant of bringing a lawsuit is minimal while legal fees to defend can be enormous. Judgments can be enormous. This phenomenon is creating a burden to our legal system by clogging the courts with lawsuits that may have little or no merit. As a result, many individuals are victims of those who hope to capitalize on our legal system that encourages lawsuits but does virtually nothing to deter over-zealous attorneys and their clients.

A business method is needed that enables protection of assets from legal risks that arise either because insurance against negligent acts, omissions, or casualty loss is unaffordable or unavailable; or because the costs of participating in the litigation system are so high that mounting an effective defense is unaffordable or impractical; or because subsequent events (such as divorce or bankruptcy) might impede the distributive plan intended by the Settlor of a trust at an earlier time prior to such event; or for other legitimate reasons.

Faced with this legal climate, individuals would benefit from a structured plan that conforms with the laws of the United States that could permit them (1) to protect assets from claimants; (2) to retain control over the management of the protected assets; and (3) to receive benefits from the protected assets.

The following discussion describes other methods employed to achieve asset protection and discusses why those methods are unsatisfactory or inferior.

1. Giving Assets Away:

Giving assets away can incur gift taxes and will require the donor to lose the use and enjoyment from the assets as well as control over the assets;

2. Liability Insurance:

Liability insurance is either unavailable (e.g., there is no insurance against bankruptcy or divorce) or, if available in adequate amounts, has become too expensive (e.g., professional liability insurance for many physicians has become exorbitant);

3. Placing Assets in a Limited Partnership:

This method requires an individual to contribute his or her assets to a limited partnership in which the individual becomes a general and limited partner. The result is that the individual's assets are held in the name of the partnership rather than in his or her name. The efficacy of this method is based on the theory that a creditor of a limited partner legally could not reach the partnerships' assets. Normally a creditor of a limited partner could not successfully reach the assets held in a limited partnership. However, a creditor of the general partner (who created the partnership, whose assets funded the partnership and who controls the partnership) could employ a number of legal theories that, with the aid of a sympathetic court, would force the distribution of the assets of the partnership to the partners thereby rendering those assets available to creditors. Alternatively, under established law governing partnerships, a limited partner who has an active role in a limited partnership's affairs is considered to be a general partner. The general partner's interest in the partnership can be reduced to its economic value and easily taken by a creditor.

4. Stand-Alone Domestic Asset Protection Trusts (DAPTD:

To date, seven states (Alaska, Nevada, Delaware, Rhode Island, Utah, Oklahoma and Missouri) have enacted specific asset protection legislation designed to protect assets. An individual Settlor whose assets funded the trust may be a beneficiary of the trusts. To be effective, those statutes require the establishment of trusts within the jurisdiction of the enabling state with at least one local trustee to administer the trust's assets. Literally, the protected assets are owned by and under the direct control of the trustees. If properly implemented, creditors of the Settlor may not reach the assets of the trust. This method loses its effectiveness if the Settlor retains powers over the trust's assets and therefore the Settlor is not named as a trustee. The individual who desires asset protection utilizing this method loses control over the management of the protected assets.

5. Stand-Alone Offshore Asset Protection Trusts:

A number of foreign jurisdictions have enacted asset protection laws to encourage the settlement of trusts in those jurisdictions. As with the domestic asset protection trust situation, those jurisdictions require the establishment of trusts within their borders which are administered by local (foreign) trustees. Unless the trusts' assets are held offshore, those assets may come under the jurisdiction of a local (U.S.) court which can ignore the offshore trust if the court deems the trust repugnant to its public policy. Therefore, the effectiveness of this method of asset protection requires the protected assets to be placed offshore and administered by foreign trustees. As with the domestic asset protection trust, the individual who desires asset protection utilizing this method loses control over the management of the protected assets.

6. Combining the Domestic Limited Partnership with the Offshore Asset Protection Trust:

This plan requires the following steps to implement: (1) an individual establishes a limited partnership in the jurisdiction of his domicile and transfers assets to the partnership in exchange for general and limited partnership interests; (2) the individual establishes an offshore trust and transfers the limited partnership interests to the trust (typically, the limited partnership interests account for 99% of the partnership's value and the retained general partnership interest accounts for 1%). This method allows the individual to retain control over the assets as general partner of the limited partnership. It thus runs the same risks as described in paragraph (3), above (placing assets in a limited partnership). It also runs the same risks as described in (5), above (the stand-alone offshore trust) if a domestic court obtains jurisdiction over the individual general partner or the assets of the partnership. When faced with litigation, therefore, the plan requires the partners (including the general partner) to vote to dissolve the limited partnership and remove the assets to the offshore jurisdiction and therefore beyond the reach of a domestic court. This action runs the risk that the domestic court will ignore the foreign trust as repugnant to its public policy and hold the individual in contempt if the assets are not repatriated and made available to the individual's creditors.

7. Combining the Domestic Limited Partnership with the Domestic Asset Protection Trust:

This plan is similar to the plan described in (6), above, (combining the domestic limited partnership with the offshore asset protection trust) except that the second step entails the creation of a domestic asset protection trust instead of an offshore asset protection trust. This methods allows the individual to retain control over the assets as general partner of the limited partnership. It thus runs the same risks as described in (3), above, (placing assets in a limited partnership).

### SUMMARY OF THE INVENTION

Briefly stated the invention is practiced by combining a domestic asset protection trust (DAPT) with a domestic limited liability company (LLC).

The invention may be summarized as a method by which an individual can manage his own selected assets, receive the benefits from the selected assets and protect the selected assets from claimants, comprising the steps of:

selecting one of the states of the United States of America having (1) a statute governing the establishment of a limited liability company (LLC) and (2) a statute governing the establishment of a domestic asset protection trust (DAPT), establishing a one member manager-managed LLC in the selected state in the name of said individual as the sole member, transferring selected assets of said individual to said one member LLC, settling a DAPT in the selected state for the benefit of said individual, assigning ownership of said LLC to said DAPT, and managing the selected assets in said DAPT for the benefit of said individual.

This method avoids the failings of the above-described methods 1-6 of the prior art. It affords asset protection for the transferred assets without requiring the transferor's loss of control over the management of, or the ability to benefit from, the transferred assets. This method incorporates the features of newly-enacted laws of (to date) only seven domestic states (Alaska, Delaware, Nevada, Rhode Island, Utah, Oklahoma, and Missouri) which permit asset protection with self-settled trusts (that is, an irrevocable trust in which the Settlor is a permissive beneficiary).

### DRAWING

FIG. 1 of the drawing is a simplified block diagram illustrating the first step in the business method,

FIG. 2 of the drawing is a simplified block diagram illustrating the second step in the business method,

FIG. 3 of the drawing is a simplified block diagram illustrating the third step in the business method, and

FIG. 4 of the drawing is a simplified block diagram illustrating the final legal entity structure.

### DETAILED DESCRIPTION

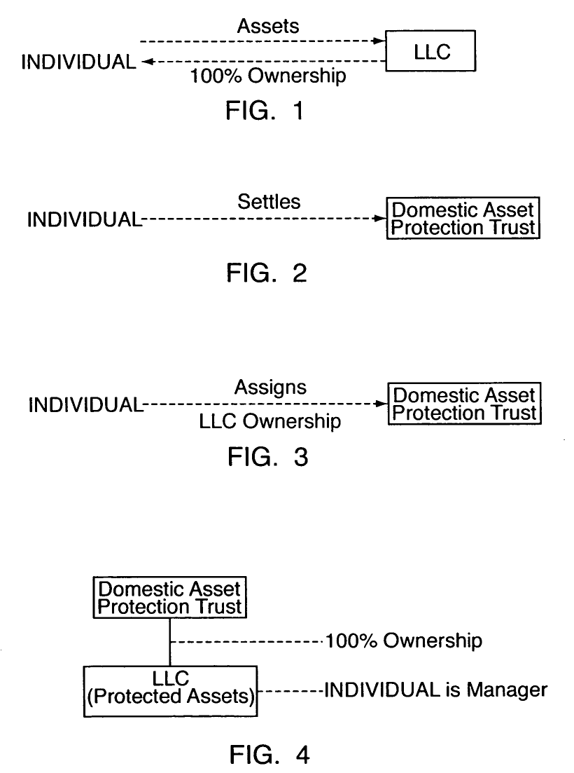

The method requires the following steps, as shown in FIGS. 1-3 of the Drawing.

FIG. 1. An individual creates a one-person domestic limited liability company (LLC) in an asset protection state (Alaska, Delaware, Nevada, Rhode Island, Utah, Oklahoma or Missouri) and transfers assets to the LLC;

FIG. 2. The individual settles an irrevocable Domestic Asset Protection Trust (DAPT) that complies with the laws of an asset protection state (e.g., The Qualified Dispositions in Trust Act of Rhode Island)

FIG. 3. The individual assigns his entire interest in the LLC to the Trust.

The order of carrying out the steps depicted in FIGS. 1 and 2 may be reversed without impairing the efficacy of the method.

The LLC's Articles of Organization and Operating Agreement require management by Managers (not by Members). There is no restriction on who may serve as Manager. Therefore, the individual who initiates the plan may serve as Manager, thereby retaining control over the assets.

The Trust has the following features:

The Trust contains provisions to ensure that a taxable gift does not occur when the Settlor transfers property, such as his interest in the LLC to the Trust. A taxable gift is avoided if the Settlor of the trust retains certain powers over the trust. For example, “a special testamentary power of appointment” giving the Settlor the power to appoint the trust corpus to any person (other than the Settlor himself, his estate, his creditors or the creditors of his estate) will prevent the transfer of property by the Settlor to the trust from being a taxable gift.

There are three classes of Trustees:

an Administrative Trustee who is a resident of the asset protection state;

an Investment Trustee who may be a resident of any state; and

an Independent Trustee, who may be a resident of any state, but must not be subservient to the Settlor.

There are up to three Protectors who monitor the Trustees and who have the power to replace Trustees.

The Protectors may be residents of any state. However, to achieve maximum asset protection, at least one Protector domiciled in a foreign jurisdiction is desirable.

The Trust operates in the following manner (pursuant to its provisions)

If suit is filed against a beneficiary of the Trust, the Trust operates as follows:

1. If suit is filed in a jurisdiction with enacted asset protection legislation, no action is required.

2. If suit is filed in a jurisdiction without enacted asset protection legislation, the Protectors are required to immediately replace any Trustee who is a resident of the state where the action is filed with Trustees who are residents of a jurisdiction with enacted asset protection legislation.

3. If deemed necessary, the Trustees remove all assets located in the jurisdiction without enacted asset protection legislation to a jurisdiction with enacted asset protection legislation. Such jurisdictions may be either within the United States or outside the United States.

4. The Trust mandates that its Trustees and Protectors must act consistent with the objectives of the Settlor as stated in the Trust. The Trustees and Protectors must act (or refuse to act) to protect the assets from a claimant.

The disclosed business method avoids the shortcomings of the prior art methods that utilize limited partnerships because no individual holds an ownership interest in the entity (the LLC) that holds the protected assets. An individual's legal status as manager (not member) of the LLC is fundamentally different from an individual's legal status as a partner in a limited partnership. Therefore, a court cannot inquire into the nature of an individual's ownership interest in the LLC (he or she has none) or compel action under the threat of being held in contempt (the powers and authority of the LLC's manager are strictly limited—the manager has no power to distribute assets).

The disclosed business method also avoids the shortcomings that utilize the offshore asset protection trusts because it is not necessary that the protected assets leave the U.S. for effective protection. Also, a domestic asset protection trust settled in accordance with domestic creditor protection statutes avoids the public policy problem described above because the U.S. court in which the creditor obtains a judgment has no jurisdiction over anyone who has authority to act on behalf of the asset protection trust, its assets or its trustees.

1. Method for managing the assets of an individual, comprising the steps of:
selecting one of the states in the United States of America having (1) a statute governing the establishment of a limited liability company (LLC) and (2) a statute governing the establishment of a domestic asset protection trust (DAPT),
establishing a one member manager-managed LLC in the selected state in the name of said individual as the sole member,
transferring selected assets of said individual to said one member LLC,
settling a DAPT in the selected state for the benefit of said individual as settlor of said DAPT,
assigning ownership of said LLC to said DAPT, and
managing the selected assets in said DAPT for the benefit of said individual.

2. The method according to claim 1 wherein said step of establishing an LLC comprises drawing Articles of Organization and Operating Agreement for said LLC that require a sole member of the LLC and a Manager of assets transferred to the LLC.

3. The method according to claim 1, wherein said step of settling a DAPT comprises drawing a trust instrument containing provisions whereby said step of assigning ownership of said LLC to said DAPT does not create a taxable gift.

4. The method according to claim 1 wherein said step of settling a DAPT comprises drawing a trust instrument defining a plurality of classes of trustees to include at least one each of an Administrative Trustee, an Investment Trustee and an Independent Trustee.

5. The method according to claim 4, wherein said Administrative Trustee is a resident of said selected state.

6. The method of claim 4, wherein said Investment Trustee may be a resident of any one of the states in the United States of America.

7. The method of claim 4, wherein said Independent Trustee may be a resident of any one of the states in the United States of America, but must not be subservient to said settlor.

8. The method according to claim 1 wherein said step of settling a DAPT comprises drawing a trust instrument defining a plurality of Protectors to monitor the trustees and having the power to replace trustees.

9. The method according to claim 8 wherein at least one of said Protectors is domiciled in a jurisdiction foreign to the United States of America.

10. The method according to claim 1, and adding the additional step of protecting the assets of the DAPT in the event that a suit is filed against a defendant trustee residing in a state other than said selected state by causing a Protector to replace said defendant trustee with a trustee residing in a state having a statute governing the establishment of a domestic asset protection trust (DAPT).

11. The method according to claim 1, and adding the additional step of protecting the assets of the DAPT by transferring assets located in a state not having a statute governing the establishment of a domestic asset protection trust to a state which does have a statute governing the establishment of a domestic asset protection trust.
